(19) United States
(12) Patent Application Publication
(10) Pub. No.: US 2003/0103259 A1
(43) Pub. Date: Jun. 5, 2003

(54) Tunable optical filter

(76) Inventors: William J. Miller, Horseheads, NY (US); Mark L. Morrell, Horseheads, NY (US); Michael H. Rasmussen, Millport, NY (US)

Correspondence Address: CORNING INCORPORATED, SP-TI-3-1, CORNING, NY, 14831

(21) Appl. No.: 09/929,468

(22) Filed: Aug. 13, 2001

(51) Int. Cl. G02F 1/33

(52) U.S. Cl. 359/308

(57) ABSTRACT

The present invention includes a flexure mount. The tunable filter further includes an actuator coupled to the flexure mount, wherein the actuator elastically perturbs the flexure mount. The tunable filter also includes a Mach-Zehnder device coupled to the flexure mount. The Mach-Zehnder device includes a first tapered coupling region; a second tapered coupling region spaced apart from the first tapered coupling region; and a phase shift region disposed between the first and second tapered coupling regions.

### BACKGROUND OF THE INVENTION

1. Field of the Invention

The present invention relates generally to an optical filter, and particularly to a tunable optical filter.

2. Technical Background

Erbium-Doped fiber amplifiers are used in optical communications systems. One advantage of Erbium-Doped fiber amplifiers is that they can simultaneously amplify multiple optical channels. Ideally, the gain across the optical channels being amplified by an Erbium-Doped fiber amplifier would be flat; that is to say that each channel would receive the same amount of amplification. The gain bandwidth of Erbium-Doped fiber amplifiers however is not flat over the spectral range of interest for optical communication systems. Without correction, this gain imbalance is additive at each Erbium-Doped fiber amplifier used in the optical communication system resulting in large imbalances in the power between the amplified optical channels.

Variable optical attenuators are used in Erbium-Doped fiber amplifiers in order to compensate for this gain imbalance. The flat spectral response of typical variable optical attenuators is not optimum. One approach that has been proposed to improve the spectral response of variable optical attenuators is to use slope variable optical attenuators.

Slope variable optical attenuators seek to generate a linear slope change by superimposing two sinusoidal response filters with a nominal phase difference of 180 degrees. By adjusting the relative phase and amplitude from nominal the slope variable optical attenuators can generate an approximately linear response. These slope variable optical attenuators offer the advantages that the impact on optical signal to noise ratio and pump power adjustments are minimized, by reducing the overall change in insertion losses.

These slope variable optical attenuators require the coordinated adjustment of multiple parameters in order to generate the desired spectral response. Such coordination is difficult.

### SUMMARY OF THE INVENTION

There is a need for a simpler device for providing gain tilt control, such as, for example a tunable filter that is a slope adjusting filter, in fiber optic communication systems and the devices therein. A slope adjusting filter is a filter that when tuned has the characteristic that over a particular range of wavelengths its change in insertion loss (IL) may be represented generally by the expression IL=A·λ+B, where A(the slope) is variable, λ is wavelength and B is the intercept. Where the filter is further characterized in that the change in average insertion loss over the range of wavelengths is small and the insertion loss pivots about a narrow waveband.

One embodiment of the tunable filter of the present invention includes a flexure mount. The tunable filter further includes an actuator coupled to the flexure mount, wherein the actuator elastically perturbs the flexure mount. The tunable filter also includes a Mach-Zehnder device coupled to the flexure mount. The Mach-Zehnder device includes a first tapered coupling region; a second tapered coupling region spaced apart from the first tapered coupling region; and a phase shift region disposed between the first and second tapered coupling regions.

In another embodiment, the tunable filter of the present invention includes a base. The tunable filter further includes a cantilever member coupled to the base. The cantilever member includes a mounting surface, wherein the bending stiffness of the cantilever member varies along the length of the cantilever member. The tunable filter also includes an actuator engageable with the cantilever member. Wherein the actuator is disposed to engage the cantilever member near the free end of the cantilever member. Wherein the actuator selectively perturbs the cantilever member. The tunable filter also includes a Mach-Zehnder device coupled to said mounting surface. The Mach-Zehnder device includes a first tapered coupling region; a second tapered coupling region spaced apart from the first tapered coupling region; and a phase shift region disposed between the first and second tapered coupling regions.

In another embodiment, the tunable filter of the present invention includes a base and a filter mount coupled to the base. Wherein the bending stiffness of the filter mount varies along the length of the filter mount. The tunable filter further includes a Mach-Zehnder device coupled to the filter mount. The Mach-Zehnder device includes a first tapered coupling region; a first sleeve disposed about the first tapered region; a second tapered coupling region spaced apart from the first tapered coupling region; a second sleeve disposed about the second tapered region; and a phase shift region disposed between the first and second tapered coupling regions, the phase shift region having a midpoint. The tunable filter also includes a first clamp engageable with the first sleeve, wherein the first clamp fixedly clamps the first sleeve to the filter mount and a second clamp engageable with the second sleeve, wherein the second clamp fixedly clamps the second sleeve to the filter mount. The tunable filter also includes an actuator engageable with the filter mount, wherein the actuator is selectively positionable so as to displace at least a portion of the filter mount. Wherein the bending stiffness of the filter mount varies so as to have a desired value at a predetermined location. Wherein said midpoint is disposed proximate to said predetermined location. Wherein the displacement of the at least a portion of said filter mount results in a change in the optical characteristics of the phase shift region.

One advantage of the present invention is that the average excess loss of the present invention is significantly less than that of a slope variable optical attenuator.

Another advantage of the present invention is that only a single parameter needs to be adjusted to obtain a desired spectral gain change.

Another advantage of the present invention is that it has a very specific stationary insertion loss function over the spectral range of operation.

Another advantage of the present invention is that the first derivative of the insertion loss function with respect to wavelength corresponds to the desired target spectral gain change of the amplifier.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely examples of the invention, and are intended to provide an overview or framework for understanding the nature and character of the invention as it is claimed. The accompanying drawings are included to provide a further understanding of the invention, and are incorporated into and constitute a part of this specification. The drawings filter mount 14. Additionally, the Mach-Zehnder device 16 is oriented such that the fibers 30, 32 are in the X-Y plane.

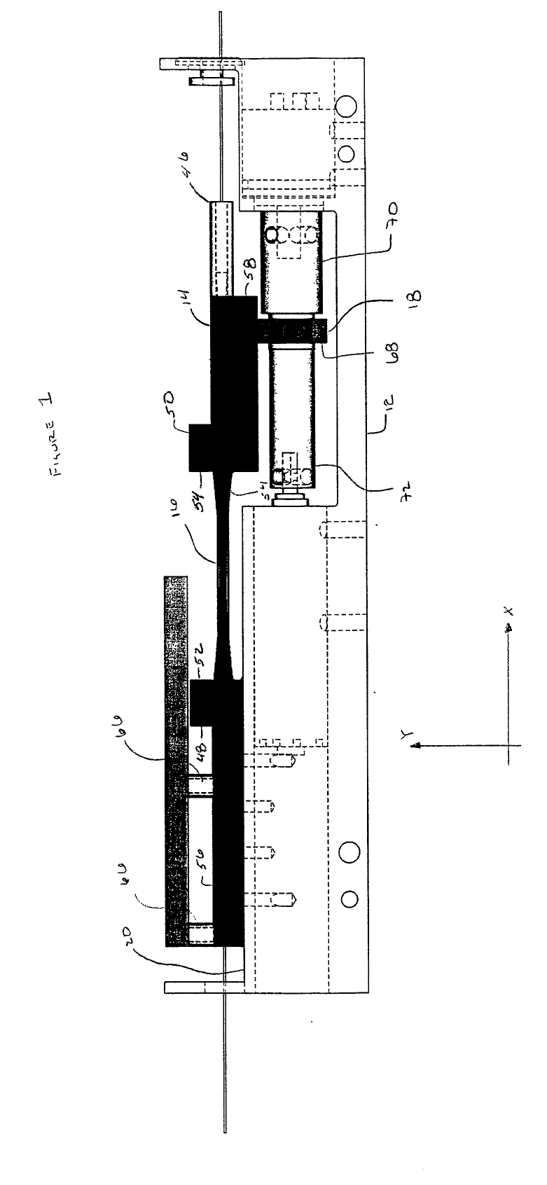

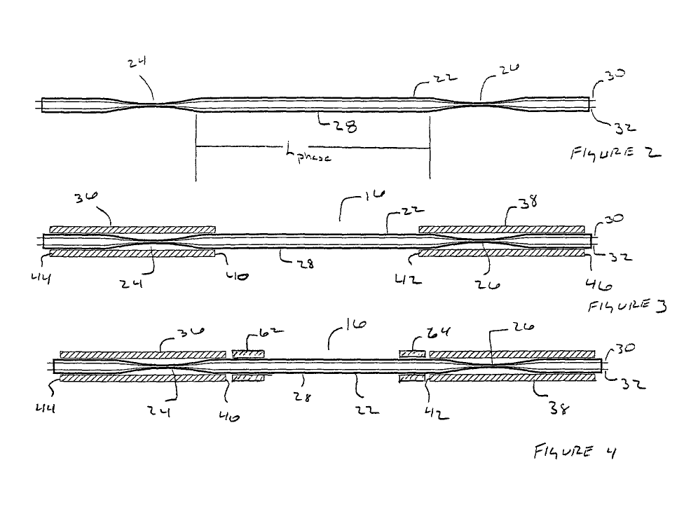

In an alternative embodiment, as shown in FIG. 4, the Mach-Zehnder device 16 includes a third sleeve 62 and a fourth sleeve 64 located between the first and second sleeves 36, 38. The first and second clamps 48, 50 used to couple the Mach-Zehnder device 16 to the filter mount 14 are positioned to engage the third and fourth sleeves 62, 64. The third and fourth sleeves are spaced apart from one another and preferably are spaced as far as apart as possible with out contacting the first and second sleeves 36, 38. The third and fourth sleeves 62, 64 may be made from glass, metal or another suitable material. In one embodiment the third and fourth sleeves 62, 64 are INVAR tubes. The Mach-Zehnder device 16 is positioned on the filter mount 14 so that the phase shift region 28 is located over the central region 60 of the filter mount 14. Additionally, the Mach-Zehnder device 16 is oriented such that the fibers F1, F2 are in the X-Y plane.

One end 56 of the filter mount 14 is coupled to the mounting surface 20 of the base 12, such as, for example by four screws 66. The central region 60 and the second end 26 of the filter mount 14 are cantilevered out from the mounting surface 24.

It will be apparent to those of ordinary skill in the art that modifications and variations may be made to the base 12 and filter mount 14. For example, rather than being two separate pieces as detailed above, the base 12 and the filter mount 14 may be incorporated into a single unitary component, such as, for example a machining.

The actuator 18 is positioned to engage the second end 58 of the fiber mount 14. The actuator 18 selectively deflects the cantilevered portion of the filter mount 14. The deflection of the filter mount 14 results in the bending of the phase shift region 28 of the Mach-Zehnder device 16. Bending of the phase shift region 28 changes the center wavelength of the Mach-Zehnder device 16.

In one embodiment, the actuator 18 is a rotating cam 68. The rotating cam 68 may be an eccentrically mounted circular cam or may be an elliptical cam mounted on a central axis or may be cam shaped to move displace the free end of the cantilevered portion of the filter mount 14 in a predetermined manner, such as, for example when the rotating cam 68 has an involute profile. The actuator 18 also includes a drive mechanism 62, such as, for example an electric motor. In one embodiment, the drive mechanism 62 is a stepper motor having 20 steps per revolution that is coupled to a 64:1 reduction gearbox which in turn drives the rotating cam 68.

The amount of rotation of the rotating cam 68 determines the deflection of the fiber mount 14. The amount of deflection of the fiber mount 14 is directly related to the deformation of the phase shift region 28 of the Mach-Zehnder device 16. As previously noted, bending of the phase shift region 28 changes the center wavelength of the Mach-Zehnder device 16, thus allowing the tunable filter of the present invention to be tuned. The tunability of the Mach-Zehnder device 16 is limited, however, by reliability concerns. For example, for a typically constructed multi-clad Mach-Zehnder device 16, such as those described in U.S. Pat. No. 5,295,205 to Miller and Nolan, having a phase shift region 28 of about 45 mm and first and second clamps 44, 46 are each about 6 mm wide and have a center to center spacing of about 35 mm the vertical displacement of the second clamp 46 is limited to less than 0.25 mm.

The deflection of the filter mount 14 may be constrained to fall within predetermined limits by incorporating physical stops into tunable filter 10 of the present invention. For example, when the actuator 18 includes a rotating cam 68, the physical stops may, for example, limit the rotation of the rotating cam 68. In an alternative embodiment, in which the actuator 18 includes a drive mechanism 62 that is an electric motor to drive the rotating cam 68, the physical stops are replaced by a motor controller and a position sensor. The position sensor produces a signal indicative of the deflection of the filter mount 14. The position sensor may for example be a potentiometer 72 coupled to the rotating cam 68. The potentiometer 72 is calibrated to produce a variable signal that varies is a predetermined manner with respect to the angular position of the rotating cam 68. The motor controller is then programmed to use the signal from the position sensor to limit the deflection of the filter mount 14.

The center wavelength of the tunable filter 10 of the present invention may also be selected using the signal from the position sensor. In this embodiment, the Mach-Zehnder device 16 is tuned to have the desired optical characteristics by comparing the deflection of the filter mount 14 and hence the bending of the phase shift region 28 to a reference chart or table the correlates phase shift region 28 bending to the center wavelength of the Mach-Zehnder device 16.

In an alternative embodiment, the Mach-Zehnder device 16 is tuned by analyzing the output signal from the tunable filter 10 and bending of the phase shift region 28 until the output signal from the tunable filter 10 posses predetermined optical characteristics. In this embodiment, the bending of the phase shift region 28 is still limited for reliability reasons and the aforementioned deflection limiting means are used.

A tunable filter as describe above is particularly well-suited to applications where a filter with an essentially parabolic response is tunable in a manner that changes the center wavelength of the filter but otherwise leaves the shape of the filtering function unchanged. Such an application is disclosed in U.S. patent application Ser. No. 09/809,882, entitled “Single Parameter Gain Slope Adjuster for an Optical System” which is incorporated herein by reference in its entirety.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A tunable filter comprising:
a flexure mount;
an actuator coupled to said flexure mount, wherein said actuator elastically perturbs said flexure mount; and
a Mach-Zehnder device coupled to said flexure mount, said Mach-Zehnder device including:
a first tapered coupling region;
a second tapered coupling region spaced apart from said first tapered coupling region; and
a phase shift region disposed between said first and second tapered coupling regions.

2. The tunable filter of claim 1 wherein said actuator includes a cam.

3. The tunable filter of claim 1 wherein said flexure mount includes a cantilever member.

4. The tunable filter of claim 3 wherein the cross section of said cantilever member varies along the length of said cantilever member.

5. The tunable filter of claim 4 wherein the cross section of said cantilever member is at a minimum at a distance from the fixed end of said cantilever member.

6. The tunable filter of claim 4 wherein said flexure mount includes a mounting surface and said Mach-Zehnder device is coupled to said mounting surface.

7. The tunable filter of claim 6,
wherein said cantilever member includes an arcuate surface disposed opposite said mounting surface; and
wherein said phase shift region is disposed symmetrically about said arcuate surface.

8. The tunable filter of claim 7 wherein said mounting surface includes a groove and said Mach-Zehnder device is disposed within said groove.

9. The tunable filter of claim 1 wherein said first tapered coupling region describes a first arc having a first radius.

10. The tunable filter of claim 9 wherein said second tapered coupling region describes a second arc having a second radius.

11. The tunable filter of claim 10 wherein said first radius and said second radius are equal.

12. The tunable filter of claim 10 wherein said first radius and said second radius are different.

13. The tunable filter of claim 2 further including:
a first sleeve disposed over said first tapered coupling region; and
a second sleeve disposed over said second tapered coupling region.

14. A tunable filter comprising:
a base;
a cantilever member coupled to said base, said cantilever member including:
a mounting surface, wherein the bending stiffness of said cantilever varies along the length of said cantilever;
an actuator engageable with said cantilever member, wherein said actuator is disposed to engage said cantilever member near the free end of said cantilever member,
wherein said actuator selectively perturbs said cantilever member;
a Mach-Zehnder device coupled to said mounting surface, said Mach-Zehnder device including:
a first tapered coupling region;
a second tapered coupling region spaced apart from said first tapered coupling region; and
a phase shift region disposed between said first and second tapered coupling regions.

15. The tunable filter of claim 14 wherein said Mach-Zehnder device further includes:
a first sleeve disposed about said first tapered coupling region; and
a second sleeve disposed about said second tapered coupling region;
wherein said first and second sleeves are coupled to said mounting surface.

16. The tunable filer of claim 15 wherein at least one of said first tapered coupling region and said second tapered coupling region describes a curve.

17. The tunable filter of claim 15 wherein said first sleeve and said second sleeve prevent said first tapered coupling region and said second tapered coupling region from flexing.

18. The tunable filter of claim 15 wherein the bending stiffness of said cantilever is a minimum at a predetermined location and mid point of said phase shift region is located proximate to said predetermined location.

19. The tunable filter of claim 15 wherein said Mach-Zehnder device is a fiber interferometer.

20. The tunable filter of claim 19 wherein wavelength profile of the Mach-Zehnder device is altered by bending said phase shift region.

21. A tunable filter comprising:
a base;
a filter mount coupled to said base, wherein the bending stiffness of said filter mount varies along the length of said filter mount;
a Mach-Zehnder device coupled to said filter mount, said Mach-Zehnder device including:
a first tapered coupling region;
a first sleeve disposed about said first tapered region;
a second tapered coupling region spaced apart from said first tapered coupling region;
a second sleeve disposed about said second tapered region; and
a phase shift region disposed between said first and second tapered coupling regions, said phase shift region having a midpoint;
a first clamp engageable with said first sleeve, wherein said first clamp fixedly clamps said first sleeve to said filter mount;
a second clamp engageable with said second sleeve, wherein said second clamp fixedly clamps said second sleeve to said filter mount;
an actuator engageable with said filter mount, wherein said actuator is selectively positionable so as to displace at least a portion of said filter mount;
wherein the bending stiffness of said filter mount varies so as to have a desired value at a predetermined location;
wherein said midpoint is disposed proximate to said predetermined location; and
wherein the displacement of said at least a portion of said filter mount results in a change in the optical characteristics of said phase shift region.

22. The tunable filter of claim 21 wherein said actuator includes a rotating cam.

23. The tunable filter of claim 22 wherein said actuator further includes a stepper motor coupled to said rotating cam.

24. The tunable filter of claim 23, wherein said rotating cam is an eccentrically mounted circular member.

25. The tunable filter of claim 21 further including a feed back controller, wherein said Mach-Zehnder device receives an input optical signal, filters said input optical signal and produces an output optical signal, wherein said feed back controller monitors the output optical signal and adjusts the position of said actuator until the output optical signal posses predetermined optical characteristics.

26. The tunable filter of claim 21 further including a sensor coupled to said actuator, wherein said sensor provides a signal corresponding to the position of said actuator.
